(19) United States
(12) Patent Application Publication
(10) Pub. No.: US 2026/0241570 A1
(43) Pub. Date: Aug. 20, 2026

(54) METHOD AND APPARATUS FOR GENERATING AND USING THREE-DIMENSIONAL OBJECT-RELATION GRAPHS FOR ROBOT NAVIGATION

(71) Applicant: SRI International, Menlo Park, CA (US)

(72) Inventors: Han-Pang CHIU, West Windsor, NJ (US); Tixiao SHAN, Princeton Junction, NJ (US); Abhinav RAJVANSHI, Pennington, NJ (US); Niluthpol MITHUN, Dayton, NJ (US); Yewei HUANG, Hackensack, NJ (US); Pritish SAHU, New Brunswick, NJ (US); Karan SIKKA, Robbinsville, NJ (US)

(21) Appl. No.: 19/540,315

(22) Filed: Feb. 13, 2026

Related U.S. Application Data
(60) Provisional application No. 63/758,921, filed on Feb. 14, 2025.
(60) Provisional application No. 63/760,964, filed on Feb. 20, 2025.
(60) Provisional application No. 63/803,304, filed on May 9, 2025.

(51) Int. Cl. B25J 9/16; G06F 16/901; G06T 17/00

(52) U.S. Cl. CPC B25J 9/1682; G06F 16/9024; G06T 17/00

(57) ABSTRACT

Method and apparatus for generating and using object-relation graphs representing a scene in which a robot is or will be operating by generating a factor graph from point cloud data produced by at least one sensor associated with the robot and processing the factor graph to form a 3D scene graph representing the scene captured in the point cloud data. The 3D scene graph produced by a given robot may be shared amongst robots to enhance their view of the scene as well as facilitate collaboration between robots to complete tasks.

### RELATED APPLICATION

This application claims benefit to U.S. Provisional Patent Application Ser. No. 63/758,921, filed 14 Feb. 2025 and entitled “3D Object-Relation Graph Generation To Robot Navigation,” U.S. Provisional Patent Application Ser. No. 63/760,964, filed 20 Feb. 2025 and entitled “Distributed Visual-Inertial SLAM With Data-Efficient Scene Graph Matching,” and U.S. Provisional Patent Application Ser. No. 63/803,304, filed 9 May 2025 and entitled “LLM-Based Multi-Agent Collaboration To Navigation In Unknown Environments,” which are each hereby incorporated herein in their entireties by reference.

### FIELD

Embodiments of the present principles generally relate to three-dimensional object-relation graphs that represent a scene in which a robot is or will be operating and, more particularly, to a method and apparatus for generating and using three-dimensional object-relation graphs for robot navigation.

### BACKGROUND

Three-dimensional (3D) object-relation graphs (also known as 3D scene graphs), where nodes depict objects and edges characterize the relationships between objects, have become popular high-level representations of large-scale 3D environments (scenes). However, there are two major limitations with current 3D scene graph generation methods. First, semantic relationships among objects are rarely used in real-time 3D scene graph generation, which limits the ability to use 3D scene graphs for robot (or other autonomous vehicle (AV)) navigation and manipulation tasks. Second, almost all 3D scene graph generation datasets are based on indoor scenes, which means corresponding 3D scene graphs are not applicable to outdoor environments.

Currently, 3D scene graph generation is primarily performed using either of two approaches. The first approach combines traditional SLAM (simultaneous localization and mapping) methods and geometric deep learning techniques, such as graph neural networks (GNN) and transformers. The resulting 3D scene graph is a layered graph which represents spatial concepts (nodes) at multiple levels (such as objects, places, rooms, and buildings) with their relations (edges). The layered structure is defined either manually or via learning techniques. Due to the lack of outdoor datasets, most of the 3D scene graphs arising from this first approach are only applicable to indoor scenes. In addition, all of the 3D scene graphs arising from this first approach only label edges across layers (such as objects “inside” a room) in the graph and none explore the semantic relations (such as “beside” and “in front of”) as edges among objects. The second approach focuses on learning a 3D flat (one-layer) scene graph directly from 3D point clouds via a GNN and instance segmentation techniques. The 3D point cloud is built either from RGBD (red, blue green, depth) sequences or RGB (red, blue, green) sequences. These techniques explicitly learn object relations without the layered structure in the 3D scene graph but are limited to small-scale indoor scenes (such as a room) due to training data constraints.

Multi-robot teams can be more efficient than a single robot in performing tasks, which is important for time-sensitive or collaborative tasks. A distributed SLAM framework is typically required to provide the perception and mapping capabilities to multi-robot teams. To implement this, the current practice is to either use a central server or use robots to exchange all point clouds for merging and mapping the entire perceived environment. However, this requires substantial network bandwidth, and it is time-consuming. Performing multi-robot SLAM efficiently and effectively with limited communication bandwidth across robots is a challenging problem. Currently, some multi-robot SLAM systems use scene graphs to reduce network transmission. However, those systems require the use of “room” information for scene graph matching across robots, which means they only work indoors.

Shared situational awareness and collaborative planning capabilities are essential for a team of robots to conduct coordinated complicated tasks in unknown large-scale environments, such as finding and assessing items in a given area. Currently, to succeed in these coordinated tasks, each robot in the team requires a large amount of knowledge about the environment. Current learning-based artificial intelligence (AI) methods, with the most popular being multi-agent reinforcement learning (MARL), require massive amounts of training for the robots to achieve reasonable performance, even for simple tasks. Moreover, significant computational resources are needed for robots to generalize to new environments. Such computational demands impede the development of distributed robots to efficiently conduct coordinated tasks in unknown large-scale environments.

Thus, there is a need for a method and apparatus for generating and using object-relation graphs for robot navigation, operational environment knowledge and robot collaboration.

### SUMMARY

Embodiments of the present invention generally relate to a method and apparatus for generating and using object-relation graphs for robot navigation as shown in and/or described in connection with at least one of the figures.

More specifically, embodiments of the invention include a method and apparatus configured to generate a three-dimensional (3D) object-relation graph representing a scene in which a robot is or will be operating by generating a factor graph from point cloud data produced by at least one sensor associated with the robot and processing the factor graph to form a 3D scene graph representing the scene captured in the point cloud data. The 3D scene graph produced by a given robot may be shared amongst robots to enhance their view of the scene as well as facilitate collaboration between robots to complete tasks.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a scenario in which at least one robot operates in accordance with at least one embodiment of the invention;

FIG. 2 depicts a block diagram of a navigation system of the at least one robot of FIG. 1 in accordance with at least one embodiment of the invention;

FIG. 3 is a graphical representation of the SLAM module and scene graph generator operation in accordance with at least one embodiment of the invention;

FIG. 4 is a flow diagram of an operational method of the SLAM module and scene graph generator in accordance with at least one embodiment of the invention;

FIG. 5 depicts a block diagram of the SLAM distribution module in accordance with at least one embodiment of the invention;

FIG. 6 depicts a flow diagram of an operational method of the SLAM distribution module in accordance with at least one embodiment of the invention;

FIG. 7 depicts a graphical illustration of a simple example of scene graph matching in accordance with at least one embodiment of the invention;

FIG. 8 illustrates an example of using decentralized collaborative planning among three robots in accordance with at least one embodiment of the invention;

FIG. 9 depicts a functional block diagram of the adaptive collaboration module of each robot in accordance with at least one embodiment of the invention;

FIG. 10 depicts an exemplary dynamic prompt format that is used by the adaptive collaboration module in accordance with at least one embodiment of the invention; and

FIG. 11 depicts a block diagram of an exemplary computing system for generating and using object-relation graphs for robot navigation in accordance with at least one embodiment of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses, systems and computer readable media for creating and/or operating a computing device to perform three-dimensional (3D) object-relation scene graph generation. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

In one embodiment, the apparatus and method includes learning 3D semantic relations among objects in an imaged scene to generate a 3D layered graph structure (which is applicable to both indoor and outdoor scenes). In one embodiment, the apparatus and method includes using 2D panoptic scene graph in a 3D world to generate layered 3D object-relation graphs across both indoor and outdoor environments.

In one embodiment, the apparatus and method includes generating and exploiting both 3D objects and a rich set of semantic relationships among objects in a 3D layered scene graph (which may be applicable to both indoor and outdoor scenes). In one embodiment, the system and method includes generating 3D semantic relations among objects, by utilizing 2D panoptic scene graph works in the 3D world via 3D semantic mapping techniques. This approach avoids previous training data constraints in learning 3D scene graphs directly from 3D data.

In one embodiment, the system and method includes a real-time 3D object-relation graph generation framework that combines 2D object relation graphs and 3D semantic mapping techniques. In one embodiment, the system and method includes generating a 2D object-relation graph from key video frames via a graph prediction network and then utilizing 3D SLAM techniques to continuously merge newly generated 2D graphs into a global 3D scene graph. This approach avoids training data constraints in prior works in learning 3D scene graphs, by leveraging existing large-scale indoor/outdoor 2D training datasets (containing object-relation labels) for graph prediction.

One advantage of the apparatus and method is it provides a real-time 3D object-relation graph generation framework for autonomous navigation in the real world. Another advantage of the apparatus and method is the capability to represent semantic relationships (e.g. “beside”, “in front of”, “on top of”) among objects. These relationships are useful to many downstream applications, such as scene manipulation, task planning, and robotics. For example, the apparatus and method may be integrated with an LLM (large language model)-based planner on a UGV (unmanned ground vehicle) to enhance graph generation capabilities across both indoor and outdoor scenes to object search tasks in real environments. Another advantage of the apparatus and method is the ability to enable an autonomous robot to use 3D scene graphs to ground LLMs for navigation in real unknown environments. Another advantage of the apparatus and method is the ability to ground object-relations in LLMs to enable understanding of fine-grained relationships among objects and generate efficient plans to a wide variety of applications, including wide-area manipulation task, such as rearranging inventory inside a factory. Another advantage of the apparatus and method is improved search efficiency for navigation tasks.

In one embodiment, the apparatus and method includes data-efficient scene graph matching designed to enhance data efficiency and facilitate better human-robot interaction and task allocation. In one embodiment, the apparatus and method includes each of two or more robots building a 3D scene graph of its own perceived environment, where scene graph is a high-level semantic representation of the environment (such as objects as nodes while edges describe relationship among objects); one or more robots sharing their scene graphs with other robot(s); and merging and matching scene graphs based on a graph matching technique. In one embodiment, the apparatus and method includes selecting point clouds around overlapped objects (e.g., based on graph matching results) and transferring them across robots to further refine the relative pose transformation and merged maps among the robots.

One advantage of the apparatus and method is the ability to save network bandwidth and to achieve greater mapping efficiency for distributed multi-robot SLAM among robots. Since the mapping efficiency is improved, the task allocation and mission planning among robots can be enhanced. Another advantage of the apparatus and method is that it can provide distributed multi-robot SLAM both indoors and outdoors. Another advantage of the apparatus and method is the ability to provide distributed multi-robot SLAM with less data being exchanged among robots (e.g., about one-tenth of the amount of data) compared to current approaches that involve dense methods that exchange entire point-clouds.

The new apparatus and method optionally includes a novel approach to leverage extensive knowledge from large language models (LLMs) to conduct coordinated tasks by a team of robots operating in unknown environments, including outdoor environments. In the apparatus and method, each robot is equipped with its own local LLM, which encodes teammate information as a knowledge graph (in addition to a scene graph) for grounding the LLM and allows for plans and actions to be conducted by the robots in a decentralized manner.

In one embodiment, the apparatus and method includes an LLM (e.g., customized version of an LLM for specific tasks) embedded in each of two or more robots, within an LLM-based multi-agent communication framework. In this embodiment, the apparatus and method includes a grounding mechanism that includes two processing modules (world model generation module and teammate modeling module), to ensure that knowledge retrieved from the local embedded LLMs adheres to physical terrain constraints, team capabilities, and conditions in the environment.

The aforementioned embodiments and features are now described below in detail with respect to the Figures.

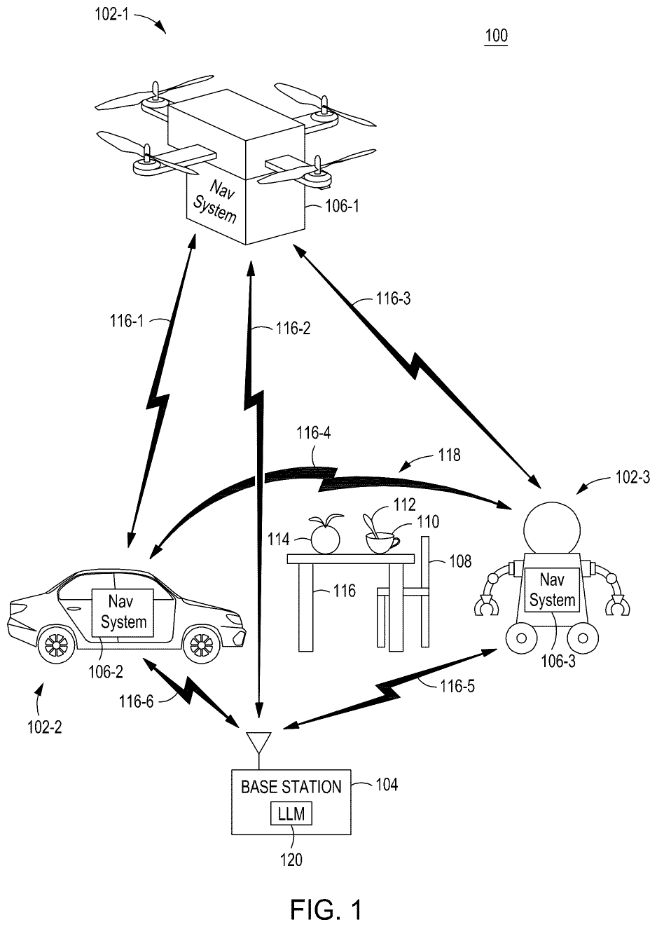

FIG. 1 depicts a scenario 100 in which at least one robot operates in accordance with at least one embodiment of the invention. The scenario 100 may include an indoor environment, an outdoor environment or both. The scenario 100 comprises at least one autonomous robot 102-1, 102-2, 102-3, . . . 102-N (collectively or individually robot(s) 102), a base station 104, and objects 118 (e.g., table 116, chair 108, items 110, 112, 114). Examples of robots 102 include, but are not limited to, a drone 102-1, a vehicle 102-2, a humanoid 102-3 and the like. Each of the robot(s) 102 comprises a navigation system 106-1, 106-2, 106-3 . . . 106-N that enables the robots 102 to autonomously or semi-autonomously navigate within the environment surrounding the robots 102. The environment surrounding the robot defines the scene in which the robot is or will be operating that is perceived by sensors associated with the robot. These sensors may be mounted to the robot, integrated into the robot or may be sensors that are remote from the robot, but supply information that is useful to the robot. In some embodiments, these remote sensors may be carried by other robots (e.g., neighboring robots) that are or will be operating within the scene.

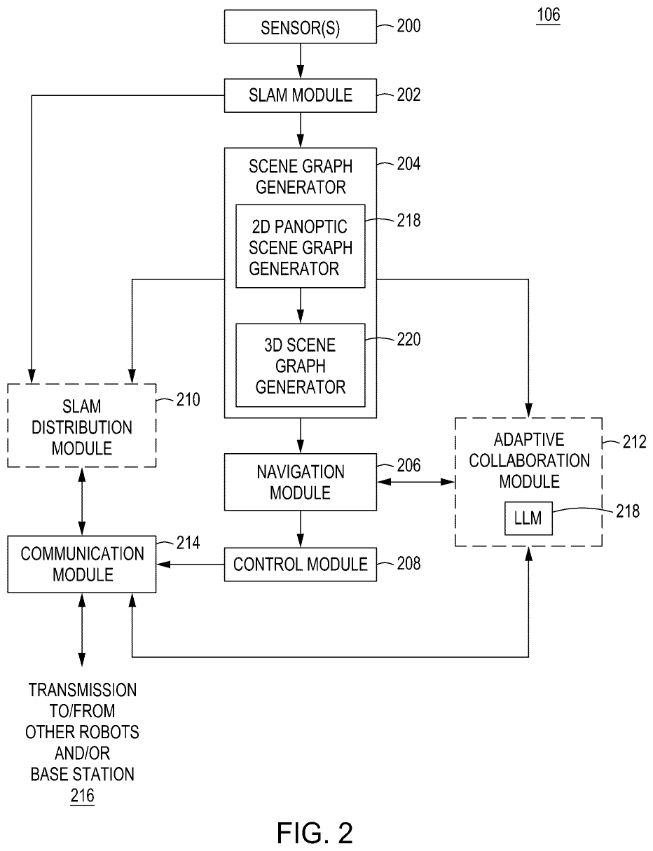

In some embodiments, during operation, each robot 102 may independently navigate on its own within the environment. In some embodiments, the robots 102 may communicate amongst themselves to share scene related information regarding the robot surroundings to enhance their ability to perform tasks as described in detail below with respect to FIGS. 2 and 5-7. In other embodiments, the robots 102 may collaboratively operate using decentralized planning to perform specific tasks as described in detail below with respect to FIGS. 2 and 8-10. For example, the task may be to pick up a fruit 114 from the table 116, where the humanoid robot 102-3 comprises at least one arm capable of picking up the fruit 114, but is blocked by the chair 108 from “seeing” the fruit 114 on the table 116. As such, the drone 102-1 flying above the table 116 can “see” the fruit 114 and map its location. The robots 102-1 and 102-3 can share this scene related information to enable to robot 102-3 to add to its world view the location of the fruit 114 and complete the task of picking up the fruit 114.

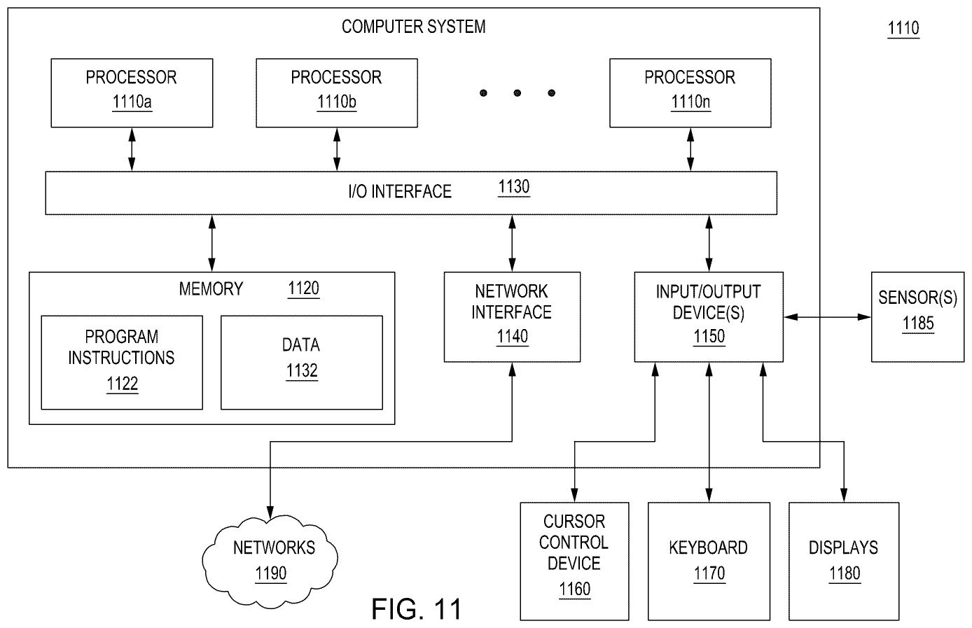

In some embodiments, the scenario 100 comprises a base station 104 that may communicate with the at least one robot 102 to gather data regarding the scenario 100 such as, but not limited to, robot diagnostic information, imagery of the environment surrounding each robot 102, task progress and completion information, robot location and pose information, robot operational status, and the like. If any of the robot(s) are not fully autonomous (semi-autonomous), the base station 104 may send control information and/or task guidance or instructions. In addition, the base station 104 may, for example, but not limited to, provide training data to the neural networks within the robots 102, provide pre-trained neural networks to the robots 102, generate a communications path to large language model (LLM) neural networks 120 for use by the robots 102, and the like. The base station may comprise a computer system as described below with respect to FIG. 11.

FIG. 2 depicts a block diagram of a navigation system 106 of the at least one robot 102 of FIG. 1 in accordance with at least one embodiment of the invention. The navigation system 106 comprises at least one sensor 200, a SLAM module 202, a scene graph generator 204, a navigation module 206, a control module 208 and a communications module 214. These sensors and modules may be implemented in hardware, software or a combination of hardware and software as described in detail below. The navigation system 106 may be implemented using a computer system as described below with respect to FIG. 11.

The at least one sensor 200 may include, but is not limited to, an inertial measurement unit (e.g., gyroscope, GNSS unit, accelerometer, and the like), one or more imaging sensors (e.g., LIDAR, RADAR, RGBD camera, video camera, acoustic sensor, thermal sensor, and the like) and the like. In one embodiment, the at least one sensor 200 comprises a LIDAR sensor or an RGBD camera to provide an RGB image and 3D depth data (e.g., a 3D point cloud). Herein, the combination of image and depth data is generally referred to as point cloud data. Furthermore, these sensors may be mounted to the robot, integrated into the robot or may be sensors that are remote from the robot, but supply information that is useful to the robot. In some embodiments, these remote sensors may be carried by other robots (e.g., neighboring robots) that are or will be operating within the scene.

The point cloud data is coupled to the SLAM module 202 to produce a factor graph comprising an odometry factor, a loop closure factor, and keyframe poses. A factor graph is a bipartite graph used to model the factorization of a global probability function. Such a graph is commonly used to represent and solve optimization problems. It typically consists of two types of nodes: Variables (the unknowns you want to estimate, like robot poses, landmark positions, or sensor biases) and Factors (the constraints or measurements, like an IMU reading or a GPS coordinate). A pose graph is a specialized, simplified version of a factor graph that may be used in some embodiments of the invention. Specifically, a pose graph is a specific type of graph where the nodes represent only the robot's poses (positions and orientations) at different points in time. The edges represent relative transformations (constraints) between those poses, typically derived from odometry or loop closures.

The factor graph is coupled to the scene graph generator 204 where a 2D panoptic scene graph generator 218 and a 3D scene graph generator process the factor graph to form a multi-level, 3D scene graph comprising object nodes and relationship edges that represent the scene being viewed by the robot.

The 3D scene graph is coupled to the navigation module 206 where it is used to facilitate determining the location and pose of the robot and to plan the next step in operation of the robot. The next operational step is coupled to the control module 208 to implement motion of the robot to fulfill the desired next step. In general, each movement of the robot generates a new keyframe resulting in an update to the 3D scene graph to capture the new view of the scene. The navigation and/or control information as well as robot state and/or status may be coupled to the communications module 214 to be communicated to the base station (104 of FIG. 1) and/or other robots (102 of FIG. 1).

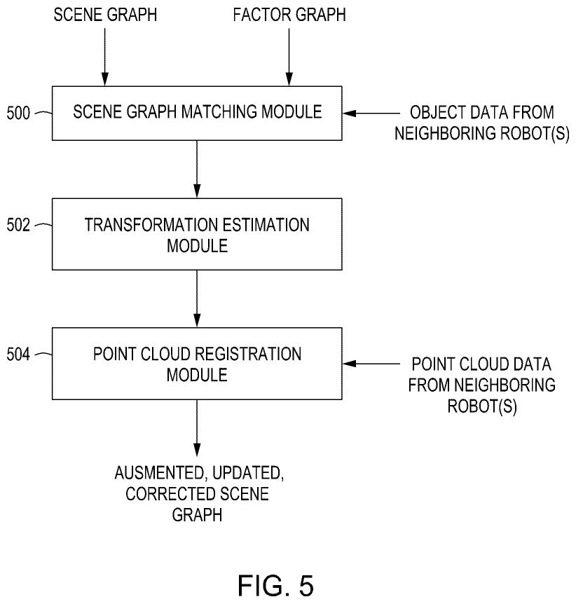

In some embodiments, the navigation system 106 may optionally comprise a SLAM distribution module 210 and/or an adaptive collaboration module 212. The SLAM distribution module 210 receives portions of 3D scene graphs from other robots via the communications module 214 (transmissions 216) and compares the local 3D scene graph to the received, remote 3D scene graphs to determine scene related information that is not locally available. This scene information may be used to update, augment and/or correct the local 3D scene graph as described in greater detail below with respect to FIGS. 5-7. The navigation system 106 may then request a remote robot to transmit limited point cloud data to the local robot so that such scene related information may be added to its scene information. The SLAM distribution module 210 also processes requests from remote robots for point cloud data such that local portions of the scene related information is sent to remote robots. In this manner, scene related information is shared amongst the robots in a bandwidth efficient manner.

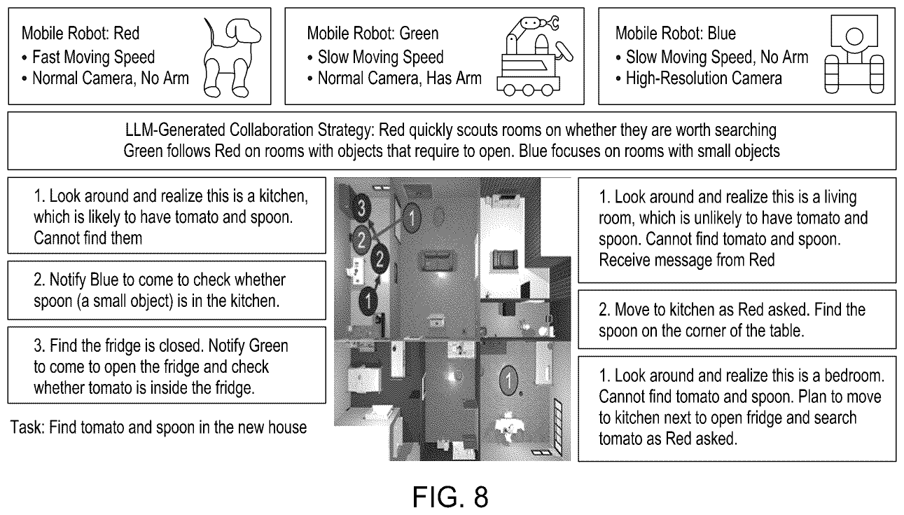

The adaptive collaboration module 212 uses the 3D scene graphs to facilitate adaptive and collaborative planning to accomplish specific tasks for the robot. As described in greater detail below, the module 212 comprises various planners that utilize a local LLM 218 and/or a remote LLM (120 in FIG. 1) to perform the planning and interaction with other robots. The adaptive collaboration module 212 communicates with the other robots and/or the base station via the communications module 214 using transmissions 216. Details of the operation of the adaptive collaboration module 212 are described below with respect to FIGS. 8-10.

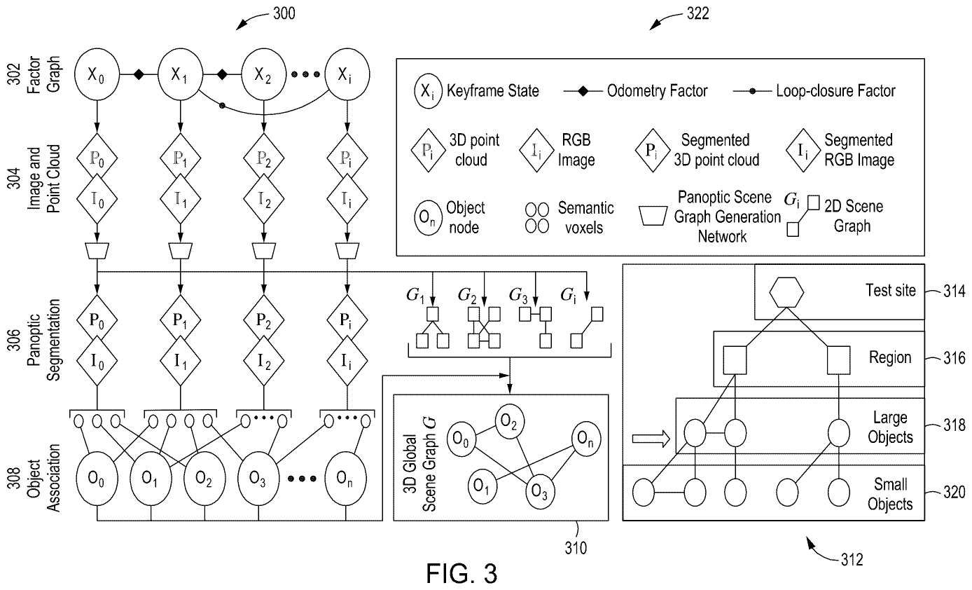

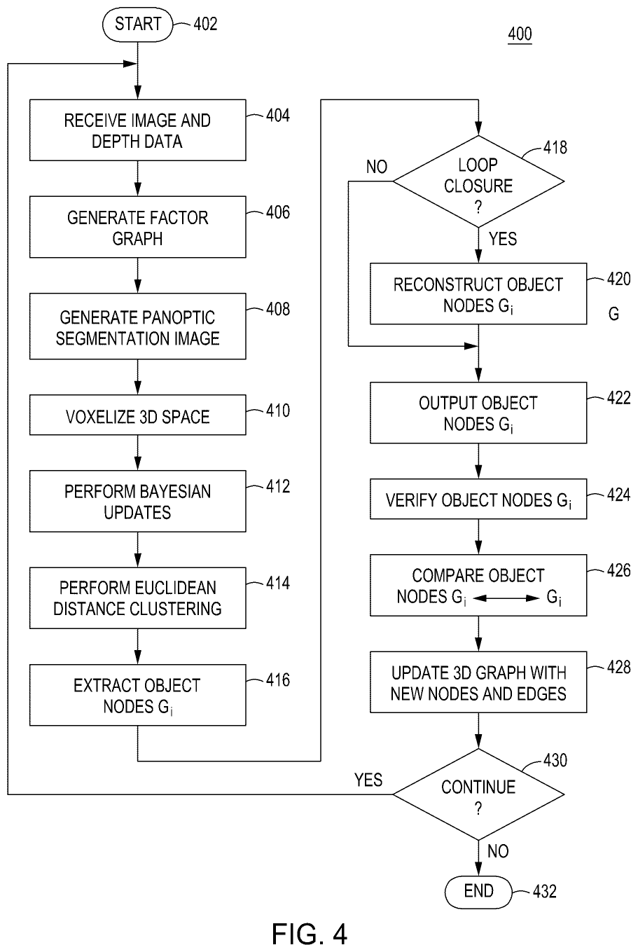

FIG. 3 is a graphical representation 300 of operation of the SLAM module and scene graph generator (202 and 204 of FIG. 2) in accordance with at least one embodiment of the invention. FIG. 4 is a flow diagram of a method of operation 400 of the SLAM module 202 and scene graph generator 204 in accordance with at least one embodiment of the invention. To best understand the following description, FIGS. 3 and 4 should be viewed simultaneously.

The method 400 begins at 402 and proceeds to 404 where the SLAM process receives the sensor imagery and depth data (also referred to as point cloud data). As described above, in one embodiment, the at least one sensor is composed of an RGBD camera or a LiDAR-camera suite, equipped on a mobile robotic platform to provide real-time 2D RGB image and 3D depth data of the perceived environment during navigation. The depth data can be in the format of either depth image or 3D point cloud as they can be effortlessly converted to each other. For consistency, a 3D point cloud is used to represent the depth data throughout the following description. The sensor system is calibrated beforehand-both system intrinsic and extrinsic parameters are available. Therefore, the SLAM process can establish pixel-to-point relations between a 2D RGB image and a 3D point cloud, and vice versa for point-to-pixel relations.

Embodiments of the invention, use a factor graph-based SLAM module (202 in FIG. 2) to register the received sensor data and provide real-time pose estimations of the host platform during navigation. The various embodiments are designed to support various types of factor graph-based SLAM modules and techniques, whether it is, for example, but not limited to, vision-based, LiDAR-based, a tightly-coupled LiDAR-vision system and the like.

At 302 and 402, a factor graph is produced comprising three main components: odometry factor, loop closure factor, and keyframe poses x. The RGB image and the 3D point cloud that are associated with keyframe xᵢ are, at 304, denoted as Iᵢ and Pᵢ, respectively. Note that instead of processing all received images and point clouds for the downstream modules, the method 400 only processes those that are associated with the keyframes, which is not only computationally efficient but also corrects their registered poses upon the occurrence of loop closure in the SLAM module.

The latest image Iᵢ and point cloud Pᵢ that are associated with the keyframe xᵢ of the SLAM module are then processed by the 2D panoptic scene graph generator (218 in FIG. 2). At 306 and 408, in one embodiment, the method 400 uses panoptic segmentation to obtain a pixel-level panoptic segmentation image Iᵢ on Iᵢ. In other embodiments, the panoptic segmentation image may be generated using object detection rather than panoptic segmentation. Specifically, whether using panoptic segmentation or object detection, for each 3D point in Pᵢ, the method 400 finds its corresponding pixel in Iᵢ utilizing the point-to-pixel relations and assigns it the same object label from Iᵢ to obtain the semantically-labeled point cloud Pᵢ.

The object vertices in the object layer are detected through semantic sensor fusion. During this process, RGB images are aligned with LiDAR scans to create a semantically labeled point cloud containing objects of interest. The RGB images are then segmented. The method 400 performs segmentation using only image data to ensure the consistency and accuracy of the semantic labeling. The point set from the corresponding LiDAR scan is then transformed into the 2D RGB image frame utilizing the LiDAR-camera extrinsics and camera intrinsics. Subsequently, the semantic label from the nearest pixel is assigned to the corresponding point. Finally, the labeled point cloud is clustered into distinct objects.

The method 400, at 410, then voxelizes the 3D space and assign each voxel a semantic label using each point in Pᵢ. Note that due to semantic label error introduced by the segmentation network, there might be voxels with different semantic labels located in it. At 412, the method 400 performs Bayesian updates for each voxel location to achieve label consistency. The semantically labeled voxel is the fundamental component of an object node in the 3D scene graph. Also, depending on the source of depth data, voxelization may greatly reduce the computation burden in this process. Lastly, at 308 and 414, the method 400 performs Euclidean distance clustering using voxels that share the same label from multiple keyframes to, at 416, extract object nodes O. For example, an object node that describes a desk in 3D space can be composed of voxels that are labeled as desk observed from multiple semantic point clouds P.

More specifically, the object layer is constructed using objects (nodes) across keyframes, with relationships (edges) weighted by Euclidean distances among objects. It can be formulated as a Linear Assignment Problem (LAP):

$${A}_{n}^{*} = argmin Σ C ⊙ {A}_{n} \qquad ( 1 )$$

$$= argmin {Σ}_{{v}_{i} ∈ {V}_{α}^{( t )}} {Σ}_{{v}_{j} ∈ {V}_{α}^{( t - 1 )}} {c}_{ij} \cdot {a}_{ij} ; \qquad ( 2 )$$

$$s . t . ∀ {v}_{j} ∈ {V}_{α}^{( t - 1 )} , {Σ}_{{v}_{i} ∈ {V}_{a}^{( t )}} {a}_{ij} \leq 1 ;$$

$$∀ {v}_{i} ∈ {V}_{α}^{( t )} , {Σ}_{{v}_{j} ∈ {V}_{α}^{( t - 1 )}} {a}_{ij} \leq 1. \qquad ( 3 )$$

Given two sets of object candidates (vertices) at the current keyframe timestep t and the previous keyframe timestep t−1, denoted as

$${V}_{{α}^{( t )}} and {V}_{{α}^{( t - 1 )}} ,$$

the cost matrix C is defined such that each element cᵢⱼ=∥pᵢ−pⱼ∥₂ represents the Euclidean distance between the object centroids pᵢ, pⱼ of the two vertices. Aₙ is the Boolean assignment matrix indicating object vertex matches between two sets with elements aᵢⱼ∈{0, 1}. If aᵢⱼ=1 and the cost cᵢⱼ<cₘₐₓ, then the ith vertex and jth vertex

$${v}_{i} ∈ {V}_{α}^{( t )}$$

and jth vertex

$${v}_{j} ∈ {V}_{α}^{( t - 1 )}$$

are matched. cₘₐₓ represents the maximum allowable distance for two object candidates across keyframes to be identified as the same object. Objects are allowed to remain unmatched to accommodate newly observed objects and objects that are no longer tracked. The well-known Hungarian Algorithm is used to solve this LAP. One benefit of using a hierarchical graph structure is the convenience of propagating updates across layers.

At 418, the method 400 queries whether a loop closure has been detected. While a loop closure happens and the keyframe poses are adjusted, object positions are also sequentially updated based on the latest keyframe that observes each object. If the query is affirmatively answered, the method 400 reconstructs the object nodes O that are affected by the SLAM module's pose corrections. The method 400 first finds the effected 3D semantic point clouds P that are associated with the corrected keyframes x. Then, the method 400 updates the labels of voxels that are previously updated by P. Lastly, the method 400 performs Euclidean distance clustering on the effected voxels again to reconstruct object nodes O. If the query at 418 is negatively answered, the method 400 outputs the object nodes.

More specifically, at 306 and 408, to perform panoptic segmentation, the method 400 generates a 2D object-relation graph from a RGB image Iᵢ associated with each keyframe. The generation task aims to model the following distribution:

$$P r ( G \vert I ) ) = P r ( M , Q , R \vert I ) \qquad ( 4 )$$

where I is the input image of size HI by W. G is the desired 2D object-relation graph which comprises a set of object masks M={m₁, m₂, . . . , mₙ} where mᵢ∈{0, 1}^{HχW}, labels Q={q₁, q₂, . . . , qₙ}, and object relations R={r₁, r₂, . . . , rₗ}. Note each of n object mask mᵢ is associated with a label qᵢ consisting of both its class and instance ID.

The method 400 uses a one-stage panoptic scene graph generator network to perform the 2D object-relation graph generation task. The network combines the panoptic segmentation process and the 2D object-relation generation into a single end-to-end neural network architecture. It separately models the objects and relations in the form of queries from two Transformer decoders, followed by a prompting-like relation-object matching mechanism. A final prediction block simultaneously generates the object masks M with labels Q and their relations R.

The method 400 leverages the 3D semantic object management mechanism of the SLAM module to continuously merge each newly generated 2D object-relation graph G; into a consistent global 3D scene graph G 310. First, each Gᵢ is translated into the 3D world by using the pixel-to-point relations with point cloud Pᵢ that are associated with the original keyframe xᵢ. At 424, the method 400 also uses 3D object set O, which is formed using information from past keyframes, to verify the object labels in Gᵢ. Inconsistent labels and masks will be corrected and updated. This improves the temporal consistency in the 3D scene graph generation process of method 400.

The 3D-translated Gᵢ is then merged into a global 3D scene graph G 310. For each new Gᵢ from a keyframe, at 426, the method 400 compares the nodes in the 3D-translated Gᵢ with the nodes in G 310. At 428, new nodes are added to G with the corresponding edges from Gᵢ. The method 400 also updates existing nodes in G using correspondent information from Gᵢ. At 430, the method 400 queries if the process should continue to process additional imagery and depth data. If the query is affirmatively answered, the method 400 proceeds to 404. Otherwise, the method 400 ends at 432.

In one embodiment, the 3D global scene graph G 310 may be accumulated and arranged into a layered structure 312. In one embodiment, the exemplary layers 314, 316, 318, 320 in the 3D scene graph 312 are manually defined. The definition aims to find a general and consistent hierarchy for both indoor and outdoor scenes. The region level (indoor rooms, outdoor areas) 316 is defined using specific landmarks (such as doors for separating rooms and roads for dividing areas). In other embodiments, an LLM may be used to automatically define the layers.

The foregoing described a core portion of an autonomous navigation system 106 that generates and uses scene graphs to represent the environment surrounding a robot such that a robot can navigate in the environment. As described below, this core portion of the navigation system can be expanded to facilitate multi-robot SLAM functionality allowing robots to share local environment information using a bandwidth efficient process.

### Optional SLAM Distribution Module 210

Returning to FIG. 2, the navigation system 106 optionally comprises a SLAM distribution module 210 that receives scene related information (e.g., scene graph and factor graph) from the SLAM module 202 and the scene graph generator 204 as well as communicates with the communication module 214. The SLAM distribution module 210 receives the locally generated 3D scene graph or a portion thereof and has access to the point cloud data related to the graph or graph portion. Using a bandwidth efficient communications protocol as described in detail below, the local robot's object data (e.g., semantic labels, centroids, point cloud data, and the like) from the 3D scene graph is shared with neighboring robots through a broadcast using the communications module 214. The SLAM distribution module 210 also receives object data and related point cloud data from the neighboring robots to enable the local robot to augment, update, or correct the local robot's 3D scene graph using information from one or more neighboring robots.

FIG. 5 depicts a block diagram of the SLAM distribution module 202 in accordance with at least one embodiment of the invention. The module 202 comprises a scene graph matching module 500, a transformation estimation module 502 and an inter-robot point cloud registration module 504. Using the scene graph matching module 500, the object data from a neighboring robot is processed to fit the data into the local robot's 3D scene graph. If the remote data is found to match at least one portion of the local scene graph, the remote graph data is deemed to be useful. Then, the local robot requests the neighboring robot that sent the useful object data to send additional scene information (e.g., point cloud data) that is related to the useful object data. The bandwidth efficient communications protocol used to share scene related information is described in detail below.

The transformation estimation module 502 processes the local and remote object data to estimate an initial transformation for inter-robot point cloud registration. The module 502 uses each matched pair of vertices in the local and remote graphs to determine the initial transformation. The initial transformation is coupled to the inter-robot point cloud registration module 504. Once the initial estimate is known, the local robot requests more detailed scene information (e.g., point cloud data) from the remote, neighboring robot. This information is then used to augment, update or correct the local 3D scene graph such that the local robot has a view of objects or portions of objects that it cannot fully “see” on its own.

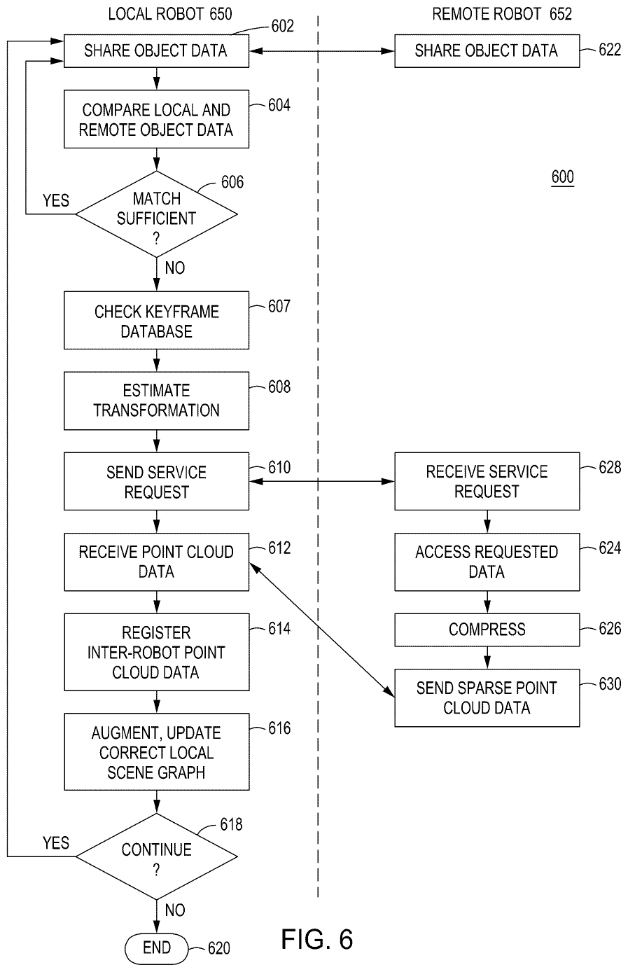

FIG. 6 depicts a flow diagram of a method 600 of operation for the SLAM distribution module 210 in accordance with at least one embodiment of the invention. The method 600 also depicts the communications that occur between a local robot 650 and neighboring (remote) robot 652. The method 600 begins at 602 and 622 with the robots 650 and 652 continuously sharing their object data from their 3D scene graphs. In one embodiment, to limit the amount of transmission bandwidth being used, only the object ID, type and centroid position are shared with the neighbors at a relatively high frequency. After receiving object data from a neighbor, at 604, the robot stores the data and compares it with its local object data as described in detail below with regard to the operation of the scene graph matching module 500. At 606, if a sufficient number of matched objects are detected, the robot sends, at 608, a service request to the corresponding neighbor for the sparse object point cloud data and the associated keyframe IDs of the matched objects. If the number of matches are insufficient, the method 600 returns to 602.

At 607, the local robot checks a keyframe database to determine whether the needed information is in the local keyframe database. As a decentralized system, initially, each robot maintains a database of its own, local keyframes. As the robots in a team operate and share information, keyframes from neighboring robots are added to the local database. Before sending a service request, the robot checks the local keyframe database to determine if the information regarding the matched objects is already known to the local robot. If the information is known, a service request is not sent. If the information is not currently in the local database, a service request is sent (as described below at 610).

At 608, the method 600 estimates a transformation between the local object data and the remote object data as described below with respect to operation of the transformation estimation module 502. At 610, when necessary, the method 600 sends a service request for the neighboring, remote robot's point cloud data comprising, but not limited to, a compressed point cloud, optimized robot state estimate, and marginalized covariances of any keyframes the local robot needs but has not yet stored. If the local robot currently has the neighbor's point cloud data (keyframe) in its local keyframe database, the robot will not send the service request and will use the point cloud data from the keyframe database.

In response to receiving the request at 628, the remote robot 652 accesses the requested data at 624 and compresses the data at 626. To optimize communication bandwidth, the shared point cloud data includes only geometric information (pose); intensity and color data are not transmitted between neighbors. The point cloud is compressed, for example, using a Point Cloud Library (PCL).

At 639, the neighbor robot 652 sends the requested data in compressed form. This data-efficient message passing strategy ensures that the latest lightweight object data is continuously shared, while the bandwidth-intensive compressed point cloud data is transmitted only when required.

At 612, the local robot 650 receives the compressed point cloud data. At 614, the method 600 registers the local point cloud data with the remote point cloud data as described below with respect to the operation of the inter-robot point cloud registration module 504. At 616, the registered point cloud data is used to augment, update or correct the local scene graph. At 618, the method 600 queries whether additional neighboring scene graph data should be processed. If the query is affirmatively answered, the method proceeds to 602; otherwise, the method 600 proceeds to 620 and ends.

### Scene Graph Matching—Simultaneous Localization and Mapping (SGM-SLAM) Module 500

In the scene graph matching module 500, the object data is represented as one or more graphs and the module 500 matches them using graph matching. During scene graph matching, object data is used to construct a fully connected undirected graph. Only selected object classes are used for matching since the estimated centroids of larger objects could vary significantly when observed from different viewpoints. The object is defined as a vertex νᵢ with attribute φ(νᵢ)=(pᵢ, lᵢ), where pᵢ denotes the centroid of the object and lᵢ denotes its semantic label. The edge eᵢⱼ connects vertices νᵢ and νⱼ, with Euclidean distance between the centroids of two objects.

The scene graph of the local robot α is defined as G_{α}= [symbol] V_{α}, E_{α} [symbol] , where V_{α}={νᵢ} denotes the set of vertices and E_{α}={eᵢⱼ} denotes the set of edges connecting the vertices. The graph constructed using object data received from a neighbor robot β is denoted as G_{β}= [symbol] V_{β}, E_{β} [symbol] . This graph matching problem can be viewed as a maximum bipartite matching problem. Since each robot has its own local world frame, Euclidean distances between object centroids cannot be used for graph matching. As such, the problem as a Quadratic Assignment Problem (QAP):

$${A}_{e}^{*} = argmax Σ {A}_{e} ⊙ U ⊙ {A}_{e} \qquad ( 5 )$$

$$= argmax {Σ}_{{v}_{i} , {v}_{j} ∈ {V}_{α}} {Σ}_{{v}_{m} , {v}_{n} ∈ {V}_{β}} {a}_{im} \cdot {u}_{ijmn} \cdot {a}_{j n} ; \qquad ( 6 )$$

$$s . t . ∀ {v}_{i} ∈ {V}_{α} , {Σ}_{{v}_{m} ∈ {V}_{β}} {a}_{im} \leq 1 ;$$

$$∀ {v}_{m} ∈ {V}_{β} , {Σ}_{{v}_{i} ∈ {V}_{α}} {a}_{im} \leq 1. \qquad ( 7 )$$

Here Aₑ is the Boolean assignment matrix where each element aᵢₘ∈{0, 1} indicates the matching status of vertices νᵢ∈V_{α} and νₘ∈V_{β}. aᵢₘ=1 means νᵢ and νₘ are matched. uᵢⱼₘₙ is an element of the 4D utility tensor U, measuring the similarity between edge eᵢⱼ from G_{α} and edge eₘₙ from G_{β}.

$${u}_{ijmn} = {d}_{ν} ( {v}_{i} , {v}_{m} ) \cdot {d}_{ν} ( {v}_{j} , {v}_{n} ) \cdot {d}_{e} ( {e}_{i j} , {e}_{m n} ) . \qquad ( 8 )$$

The function d_{ν}(·) represents the vertex-wise comparison. In this embodiment, only the labels of two objects are compared to avoid confusion caused by partially observed large objects.

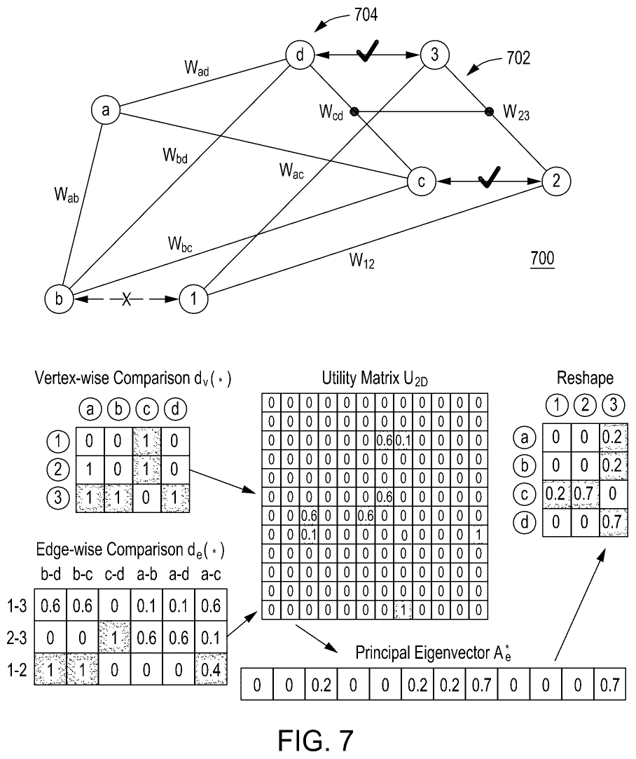

If two objects have the same label, the method sets d_{ν}(·)=1; otherwise, d_{ν}(·)=0. The edge-wise comparison is defined as dₑ(eᵢⱼ, eₘₙ)=exp(−μ|wᵢⱼ−wₘₙ|), where wᵢⱼ is the weight of edge eᵢⱼ and μ is a scaling factor. FIG. 7 depicts a graphical illustration 700 of a simple example of edge-wise scene graph matching with μ=1 in accordance with at least one embodiment of the invention. This example illustrates edge-wise matching between two graphs 702 and 704. Edge lengths represent weights, and node colors (gray and dark gray) indicate vertex types and weight wᵢⱼ=pᵢ-pⱼ₂ being the Euclidean distance between the centroids of two objects. In FIG. 7, the edge lengths represent the actual weights of the graph. Consequently, dₑ (w₁₃, w_{bd}), dₑ(w₁₂, w_{bc}) and dₑ (w₂₃, w_{cd}) are significantly higher than the dₑ(·) values of other matches. However, since vertex b and vertex 1 are of different types, d_{ν}(ν_{b}, νₗ)=0, resulting in only e₂₃ and e_{cd} being matched.

Next, the assignment matrix is vectorized as vec(Aₑ), and reshape U into a 2D matrix U_{2D}, allowing for the rewriting of Eq. (5) as:

$${A}_{e}^{*} = {argmaxvec ( {A}_{e} )}^{T} \cdot {U}_{2 D} \cdot vec ( {A}_{e} ) \qquad ( 9 )$$

In Eq. (5), aᵢⱼ is originally constrained to be Boolean. However, to make the problem more tractable, this constraint is relaxed by allowing aᵢⱼ∈[0, 1]. The solution, Aₑ*, is then given by the positive eigenvector of U_{2D} corresponding to its principal eigenvalue. Finally, the vertexwise matching of the objects can once again be formulated as an LAP similar to Eq. (1), with cost matrix C=−Aₑ*. Additionally, a minimum allowable eigenvector value is introduced to prevent mismatches during the assignment.

### Transformation Estimation Module 502

The transformation estimation module 502 provides an initial estimate for inter-robot point-cloud registration. The matched vertex pairs from local graph Ga and neighbor graph G_{β} are denoted by A_{α,β}. The goal is to estimate the relative robot frame transformation Tw_{α→}w_{β} using this matched pair set alone. For each matched object pair, ∀ [symbol] νₐ, ν_{β} [symbol] ∈A_{α,β}, p_{α} and p_{β} represent the object centroids of the corresponding vertices. The transformation relationship between these points can be expressed as:

$$[ \begin{matrix}{p}_{α} \\ 1\end{matrix} ] = {T}_{{W}_{α} \to {W}_{β} [ \begin{matrix}{p}_{α} \\ 1\end{matrix} ]} \qquad ( 10 )$$

As long as there are more than 3 non-collinear objects, the module 502 estimates Tw_{α→}w_{β} using a rigid body transformation. To avoid potential tilting due to odometry drift and ensure robustness, all objects are assumed to lie on a plane, allowing the problem to be reduced to a 2D rigid body transformation estimation.

### Inter-Robot Point Cloud Registration Module 504

The robot frame transformation estimate Tw_{α→}w_{β} is used as the coarse initial transformation estimate for inter-robot point cloud registration. The inter-robot point cloud registration module 504 refines the result by performing Iterative Closest Point (ICP) registration using the sparse object cloud associated with the matched objects.

In the scene graph, each object node vis connected to a set of keyframes (point clouds), F_{ν}={F(i)} in which the corresponding object is observed. For each matched object pair [symbol] ν_{α}, ν_{β} [symbol] , point-cloud registration is performed as follows. The target point cloud for registration is constructed by aggregating all keyframes associated with the object from local scene graph: M_{Vα}=∪ᵢF_{Vα}(i). Each F_{νβ}(j)∈F_{νβ} is processed using a sliding-window approach to construct a source cloud,

$${M}_{v β} = {⋃}_{k = - 5}^{5} {F}_{v β} ( j + k ) .$$

This source cloud M_{νβ} is then transformed into local world frame W_{α} using the transformation Tw_{α→}w_{β}. Point cloud registration between each source cloud and the target cloud is performed using ICP, and the resulting inter-robot loop closures are added into the SLAM factor graph to improve local robot state estimation. To ensure computational efficiency, each keyframe from the neighboring robot is registered with only one local keyframe. The inter-robot point cloud registration module uses the additional point cloud data to augment, update, or correct the local scene graph.

### Optional Adaptive Collaboration Module 212

The adaptive collaboration module 212 leverages large language models (LLMs) to facilitate adaptive collaboration among multiple autonomous robots for decentralized planning and navigation. The module 212 utilizes LLMs to automatically generate the collaboration strategy based on the skills of each robot in a team of robots. Specifically, the adaptive collaboration module 212 enables each robot to share its background information, such as its capability specification and operational constraints, with other robots prior to the robots preforming a team-wide task. One randomly selected robot (a team leader) feeds the assigned team task with the team background information into the LLM, for retrieving appropriate knowledge to form the collaboration strategy. This mechanism guarantees that the LLM generates feasible collaboration strategies that leverage the strengths of different robots to solve complex navigation tasks. When any robot has changes in its physical condition during navigation, it can ground the LLM again for generating a new collaboration strategy which accommodates its changed condition. The updated strategy will then be shared and executed among the team robots. In this manner, the team adapts its strategies and interactions to effectively work together under dynamic situations.

Embodiments of the invention utilize a novel three-level decentralized planning architecture to handle the complexity from cooperative navigation tasks in large-scale new environments. Each robot uses a top-level LLM-based global planner to share information among the team that is used to define the collaboration strategy. A middle-level local planner leverages the LLM to dynamically generate step-by-step plans for the individual robot based on the collaboration strategy. The step-by-step plan is then executed by a bottom-level action planner, that maps each step into a sequence of primitive actions. FIG. 8 illustrates an example of using this decentralized planning architecture among three robots (Red, Blue and Green), to search for a tomato and a spoon in a new house. Based on the LLM-generated collaboration strategy, the Red robot utilizes its fast speed to quickly scout the rooms and find that the kitchen is likely to have the two target objects. The Red robot then calls the Blue robot to come to use its high-resolution camera for locating the small spoon. It also requests the Green robot, which has the manipulation arm, to open the refrigerator (fridge) and to check whether the tomato is inside the fridge.

As shown in FIG. 8, the observation quality and the action space for each robot depends on its skills and conditions. For example, the robot (Blue) with a high-resolution camera perceives better RGBD images and semantic segmentation maps. The mobile robot with manipulator arm (Green) can issue manipulation control commands (open and close) in addition to movement control commands (turnleft, turn-right, move-forward, stop, and look-around). The team of robots is required to dynamically coordinate the search plan, depending on the perceived surroundings (i.e., the kitchen may have the tomato and spoon) and different skills (i.e., high-resolution cameras can better locate the spoon) across the team, based on the collaboration strategy.

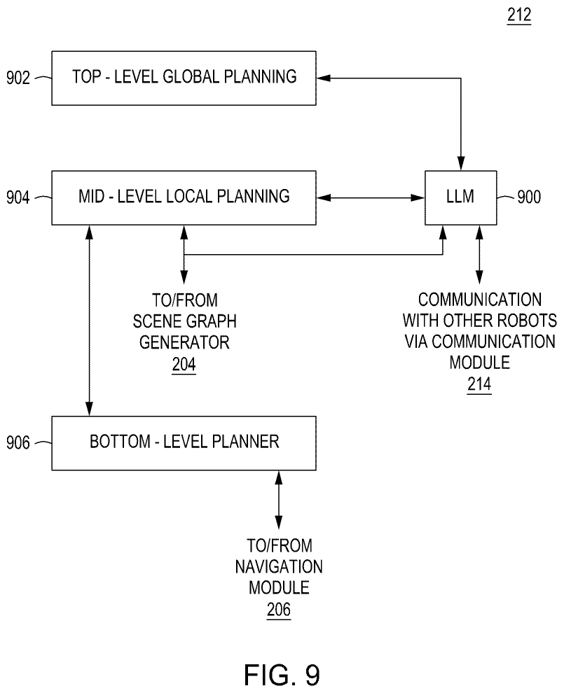

FIG. 9 depicts a functional block diagram of the adaptive collaboration module 212 of each robot in accordance with at least one embodiment of the invention. The module 212 comprises a plurality of modules: a top-level global planner 902, a middle-level local planner 904, a bottom-level action planner 906 and an LLM 900. Note, both top-level global planner 906 and middle-level local planner 904 are LLM-based planners, that enable adaptive collaboration and decentralized planning for multi-robot navigation. The LLMs used by the module 212 may be local to a given robot or may be remote from the robot and accessed via the communications module (214 of FIG. 2). The adaptive collaboration module 212 receives scene graph information from the scene graph generator (204 in FIG. 2), communicates with the other robots via the communications module (214 in FIG. 2) and sends robot navigation/operation control information based on the plan to the navigation module (206 in FIG. 2). In some embodiments, the navigation module may provide feedback to the adaptive collaboration module 212 regarding the robot's operational status (e.g., battery life, damage, location, and the like) so that the module 212 may adjust the plan to accommodate the status.

### Top-Level Global Planner 902

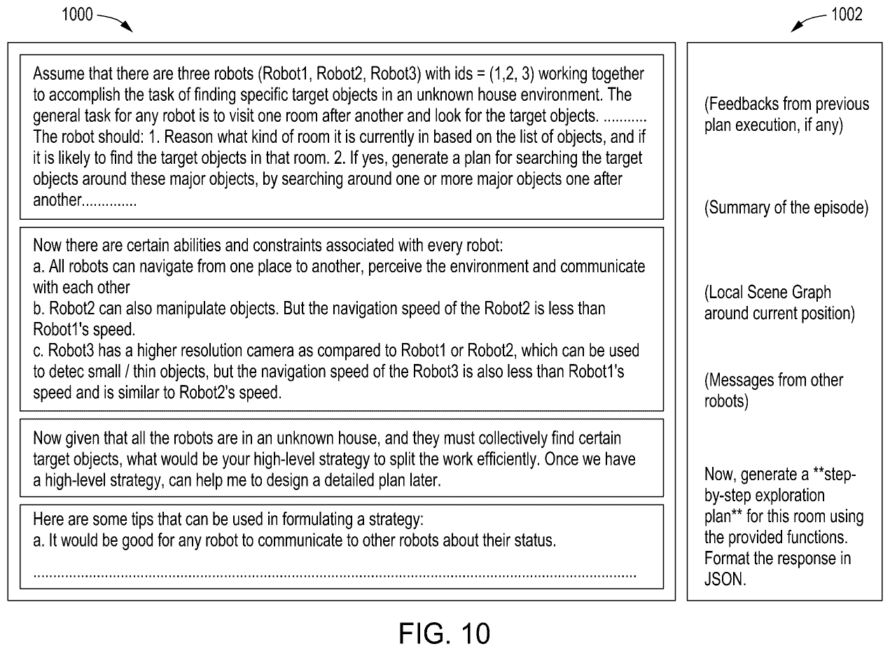

The top-level global planner 902 uses the LLM 900 to communicate background information among the team for defining the collaboration strategy. FIG. 10 shows an exemplary system prompt 1000 for this process. The prompt includes four components: team task statement, robot skills and conditions, collaboration strategy request, and tips. The component of robot skills and conditions is automatically generated based on communication across robots, while other three components are manually specified by a human that establishes the task to be performed. The chain-of-thought (CoT) prompting technique is used in two components (team task statement and tips). This technique guides the LLM to reason step-by-step as humans do, where the prompt is decomposed into logical reasoning steps and describing these steps in within the prompt. To be concise, some CoT details are omitted in FIG. 10.

The global planner 902 within a chosen robot from the team feeds this prompt to the LLM 900 to generate a collaboration strategy prior to the mission for the team of robots. The robot selection may be random or a specific type of robot capable of communicating with the LLM 900 may be specifically selected. In other embodiments, the selection may be based on current processing load being handled by the team robots and the robot with the least processing at the moment is selected. The LLM 900 may be locally located within the robot; however, typically, the LLM for generating a collaboration strategy will be remote from the robot, e.g., within the base station (LLM 120 in base station 104) or located elsewhere and accessible via a computer network.

The collaboration strategy includes a role assigned to each robot in the team, a communication mechanism among robots, and a task distribution among the team. By grounding the LLM 900 using the specifications of robot skills within the prompt, the generated strategy shall leverage the strengths of different robots to solve the task. The strategy is then shared among the team for execution. The global planner 902 also monitors the status of the robot. When the robot status changes during the mission, the global planner 902 can regenerate the collaboration strategy.

### Middle-Level Local Planner 904

The middle-level local planner 904 uses the LLM 900 to dynamically generate step-by-step plans for the individual robot based on the collaboration strategy from the top-level global planner 902. Note, each robot is provided with a list of high-level behavior functions, such as NavigationTo and OpenObject, based on its individual skills. Therefore, the LLM-generated step-by-step plan can be viewed as the composition of these behavior functions from the robot. The LLM 900 used by the local planner 904 is typically locally located in the individual robot; however, in some embodiments, the LLM 900 may be remotely located.

Specifically, each robot automatically generates and updates a short-term plan regularly using a dynamic prompt during the mission. FIG. 10 depicts an exemplary dynamic prompt format 1002 that is used by the adaptive collaboration module in accordance with at least one embodiment of the invention. The prompt format 1002 includes four dynamic components that evolve over time: feedback, summary, local scene graph, and communication messages. The feedback component describes the response from previous plan execution, such as whether it was successful. The summary component illustrates the task status and progress (such as remaining target objects and rooms already visited) which are automatically generated by the execution of behavior functions. It serves as a memory mechanism, which improves LLM's capabilities to handle long horizon tasks. The component of local scene graph is the abstracted representation of current perceived scenes. The communication messages include information received from other robots. These four components in the prompt ensure that the plan is continuously refined based on newest information known to the team to enable the team to efficiently achieve the team's joint goal in a decentralized manner. The middle-level planner 904 fully relies on the LLM to generate both search plans within rooms and transition plans across rooms, based on the collaboration strategy defined from the global planner.

### Bottom-Level Action Planner 906

As described above, the scene graph generator 204 continuously builds and expands a local 3D scene graph of the perceived environment being explored by the robot, based on its received point cloud data. The LLM 900 also retrieves information from communication messages, such as which rooms have been explored by other robots, to augment the local scene graph. The middle-level local planner 904 continuously extracts a subgraph from the full local 3D scene graph based on the current robot position, and converts the subgraph into text in the dynamic prompt that is sent to the LLM 900.

The bottom-level action planner 906, which can be either an oracle (ground truth) planner or a pretrained planner, maps each planned step from the mid-level local planner 904 into a sequence of primitive actions that the particular robot uses to fulfill a task. For example, the NavigationTo step (a short-distance point-goal navigation sub-task) can be executed by a combination of control commands (turn-left, turn-right, and move-forward). Each task step supplied to the bottom-level action planner 906 from the middle-level local planner 904 are converted to specific implementation instructions that are coupled to the navigation module 206 to cause robot motion. The navigation module 206 provides feedback to the planner 906 that indicates if the task was completed and to update the status of the local robot. The status is coupled from the bottom-level action planner 906 to the middle level local planner 904. This status information is coupled to the LLM 900 such that the LLM 900 knows the status of each robot in the team. The status may include, but is not limited to, robot battery life, robot position, task completion status, and the like. Consequently, the adaptive collaboration module 212 uses the continuously updated LLM 900 to produce, in a distributed manner, a collaboration plan for a team of robots, while the middle-level planner 904 operating in conjunction with the bottom-level planner 902 implements the collaboration plan for each individual robot member of the team. In this manner, a team of autonomous robots may be used in a coordinated manner to complete complex tasks.

FIG. 11 depicts a computer system 1100 that can be utilized in various embodiments of the present invention to implement the navigation system (106 in FIGS. 1 and 2) according to one or more embodiments.

Various embodiments of a navigation system, as described herein, may be executed on one or more computer systems, which may interact with various other devices. One such computer system is computer system 1100 illustrated by FIG. 11, which may in various embodiments implement any of the elements or functionality illustrated in FIGS. 1 through 10. In various embodiments, computer system 1100 may be configured to implement methods and functions described above. The computer system 1100 may be used to implement any other system, device, element, functionality or method of the above-described embodiments. In the illustrated embodiments, computer system 1100 may be configured to implement the navigation system 106 and implement the navigation and operational functions of a robot as processor-executable executable program instructions 1122 (e.g., program instructions executable by processor(s) 1110) in various embodiments. These program instructions 1122 and data 1132 may include neural networks in the form of, for example, but not limited to, large language models, graph neural networks, factor graphs, convolutional neural networks, recurrent neural networks, transformer networks and the like.

In the illustrated embodiment, computer system 1100 includes one or more processors 1110a-1110n coupled to a system memory 1120 via an input/output (I/O) interface 1130. Computer system 1100 further includes a network interface 1140 coupled to I/O interface 1130, and one or more input/output devices 1150, such as cursor control device 1160, keyboard 1170, display(s) 1180 and sensors 1185. In various embodiments, any of the components may be utilized by the system to receive user input described above. In various embodiments, a user interface may be generated and displayed on display 1180. In some cases, it is contemplated that embodiments may be implemented using a single instance of computer system 1100, while in other embodiments multiple such systems, or multiple nodes making up computer system 1100, may be configured to host different portions or instances of various embodiments. For example, in one embodiment some elements may be implemented via one or more nodes of computer system 1100 that are distinct from those nodes implementing other elements. In another example, multiple nodes may implement computer system 1100 in a distributed manner.

In different embodiments, computer system 1100 may be any of various types of devices, including, but not limited to, an autonomous and/or semi-autonomous robots, autonomous and/or semi-autonomous vehicles, autonomous and/or semi-autonomous drones, or in general any type of computing or electronic device that can fulfill the tasks described herein.

In various embodiments, computer system 1100 may be a uniprocessor system including one processor 1110, or a multiprocessor system including several processors 1110 (e.g., two, four, eight, or another suitable number). Processors 1110 may be any suitable processor capable of executing instructions. For example, in various embodiments processors 1110 may be general-purpose or embedded processors implementing any of a variety of instruction set architectures (ISAs). In multiprocessor systems, each of processors 1110 may commonly, but not necessarily, implement the same ISA.

System memory 1120 may be configured to store program instructions 1122 and/or data 1132 accessible by processor 1110. In various embodiments, system memory 1120 may be implemented using any non-transitory computer readable media including any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1120. In other embodiments, program instructions and/or data may be received, sent or stored upon different types of computer-accessible media or on similar media separate from system memory 1120 or computer system 1100.

In one embodiment, I/O interface 1130 may be configured to coordinate I/O traffic between processor 1110, system memory 1120, and any peripheral devices in the device, including network interface 1140 or other peripheral interfaces, such as input/output devices 1150. In some embodiments, I/O interface 1130 may perform any necessary protocol, timing or other data transformations to convert data signals from one component (e.g., system memory 1120) into a format suitable for use by another component (e.g., processor 1110). In some embodiments, I/O interface 1130 may include support for devices attached through various types of peripheral buses, such as a variant of the Peripheral Component Interconnect (PCI) bus standard or the Universal Serial Bus (USB) standard, for example. In some embodiments, the function of I/O interface 1130 may be split into two or more separate components, such as a north bridge and a south bridge, for example. Also, in some embodiments some or all of the functionality of I/O interface 1130, such as an interface to system memory 1120, may be incorporated directly into processor 1110.

Network interface 1140 may be configured to allow data to be exchanged between computer system 1100 and other devices attached to a network (e.g., network 1190), such as one or more external systems or between nodes of computer system 1100. In various embodiments, network 1190 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1140 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 1150 may, in some embodiments, include one or more display terminals, keyboards, keypads, touchpads, scanning devices, voice or optical recognition devices, camera, LIDAR sensors, RADAR sensors, thermal sensors, inertial navigation devices, or any other devices suitable for generating, entering or accessing data by one or more computer systems 1100. Multiple input/output devices 1150 may be present in computer system 1100 or may be distributed on various nodes of computer system 1100. In some embodiments, similar input/output devices may be separate from computer system 1100 and may interact with one or more nodes of computer system 1100 through a wired or wireless connection, such as over network interface 1140.

In some embodiments, the illustrated computer system may implement any of the modules, operations and methods described above, such as illustrated in FIGS. 1-10. The functions may be implemented in a robot or may be implemented partially in a robot and partially in a server (or other remote computer system). In other embodiments, different elements and data may be included.

Those skilled in the art will appreciate that computer system 1100 is merely illustrative and is not intended to limit the scope of embodiments. In particular, the computer system and devices may include any combination of hardware or software that can perform the indicated functions of various embodiments, including various types of robots and the like. Computer system 1100 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1100 may be transmitted to computer system 1100 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. An apparatus configured to generate a three-dimensional (3D) object-relation graph representing a scene in which a robot is or will be operating comprising:
a simultaneous localization and mapping (SLAM) module configured to generate a factor graph from point cloud data produced by at least one sensor associated with the robot; and
a scene graph generator, comprising a two-dimensional (2D) panoptic scene graph generator coupled to a 3D scene graph generator, configured to process the factor graph to form a 3D scene graph representing the scene captured in the point cloud data.

2. The apparatus of claim 1 wherein the at least one sensor comprise at least one of LIDAR, RADAR, thermal, and video camera.

3. The apparatus of claim 1 further comprising a navigation module, coupled to the scene graph generator, configured to utilize the 3D scene graph to move the robot within the scene.

4. The apparatus of claim 1 wherein the scene graph generator is further configured to generate a panoptic segmentation image, voxelize the point cloud data using the panoptic segmentation image to form a 3D image, perform Euclidean distance clustering to determine objects within the 3D image, and extract the objects as nodes for the 3D scene graph.

5. The apparatus of claim 4 wherein, upon detecting a loop closure, the scene graph generator reconstructs the object nodes in the 3D scene graph.

6. The apparatus of claim 4 wherein the extracted nodes are added to an existing 3D scene graph.

7. The apparatus of claim 1 further comprising a SLAM distribution module configured to sharing at least a portion of the 3D scene graph with a neighboring robot.

8. The apparatus of claim 7 wherein the SLAM distribution module is configured to receive at least one portion of a remote 3D scene graph from a neighboring robot and comprises:
a scene graph matching module configured to match the received at least one portion of the remote 3D scene graph to a local 3D scene graph;
a transformation estimation module, coupled to the scene graph matching module, configured to determine a transformation to align the at least one portion of the remote 3D scene graph to the local 3D scene graph; and
a point cloud registration module, coupled to the transformation estimation module, configured to align remote point cloud data associated with the at least one portion of the remote 3D graph with the point cloud data and using the aligned remote point cloud data to augment, update or correct the 3D scene graph.

9. The apparatus of claim 1 further comprising an adaptive collaboration module comprising:
a top-level global planner configured to generate a global collaboration plan, using at least one large language module (LLM), that defines collaboration amongst a plurality of robots that include the robot;
a middle-level local planner configured utilize the global collaboration plan and at least one LLM to generate a step-by-step plan of operation for the robot; and
a bottom-level action planner configured to control the robot to implement the step-by-step plan.

10. A method for generating a three-dimensional (3D) object-relation graph representing a scene in which a robot is or will be operating comprising:
generating a factor graph from point cloud data produced by at least one sensor associated with the robot;
processing the factor graph to form a 3D scene graph representing the scene captured in the point cloud data.

11. The method of claim 10 wherein the at least one sensor comprise at least one of LIDAR, RADAR, thermal, and video camera.

12. The method of claim 10 further comprising utilizing the 3D scene graph to move the robot within the scene.

13. The method of claim 10 wherein further comprising generating a panoptic segmentation image, voxelizing the point cloud data using the panoptic segmentation image to form a 3D image, performing Euclidean distance clustering to determine objects within the 3D image, and extracting the objects as nodes for the 3D scene graph.

14. The method of claim 13 wherein, upon detecting a loop closure, reconstructing the object nodes in the 3D scene graph.

15. The method of claim 13 wherein the extracted nodes are added to an existing 3D scene graph.

16. The method of claim 10 further comprising sharing at least a portion of the 3D scene graph with a neighboring robot.

17. The method of claim 16 further comprising:
receiving at least one portion of a remote 3D scene graph from a neighboring robot;
matching the received at least one portion of the remote 3D scene graph to a local 3D scene graph;
determining a transformation to align the at least one portion of the remote 3D scene graph to the local 3D scene graph;
aligning remote point cloud data associated with the at least one portion of the remote 3D graph with the point cloud data; and
using the aligned remote point cloud data to augment, update or correct the 3D scene graph.

18. The method of claim 10 further comprising:
generating a global collaboration plan, using at least one large language module (LLM), that defines collaboration amongst a plurality of robots that include the robot;
utilizing the global collaboration plan and at least one LLM to generate a step-by-step plan of operation for the robot; and
a controlling the robot to implement the step-by-step plan.

19. An apparatus configured to generate a three-dimensional (3D) object-relation graph representing a scene in which a robot is or will be operating comprising:
a simultaneous localization and mapping (SLAM) module configured to generate a factor graph from point cloud data produced by at least one sensor associated with the robot;
a scene graph generator, comprising a two-dimensional (2D) panoptic scene graph generator coupled to a 3D scene graph generator, configured to process the factor graph to form a 3D scene graph representing the scene captured in the point cloud data; and
a SLAM distribution module configured to sharing at least a portion of the 3D scene graph with a neighboring robot.

20. The apparatus of claim 19 further comprising an adaptive collaboration module comprising:
a top-level global planner configured to generate a global collaboration plan, using at least one large language module (LLM), that defines collaboration amongst a plurality of robots that include the robot;
a middle-level local planner configured utilize the global collaboration plan and at least one LLM to generate a step-by-step plan of operation for the robot; and
a bottom-level action planner configured to control the robot to implement the step-by-step plan.
